(19) United States
(12) Patent Application Publication
(10) Pub. No.: US 2005/0111392 A1
(43) Pub. Date: May 26, 2005

(54) Broadcast/narrowcast dual mode satellite

(76) Inventors: Mark D. Thompson, Hood River, OR (US); William L. Snell, Monmouth, OR (US)

Correspondence Address: IPSOLON LLP, 805 SW BROADWAY, #2740, PORTLAND, OR, 97205, US

(21) Appl. No.: 10/846,484

(22) Filed: May 13, 2004

Related U.S. Application Data
(60) Provisional application No. 60/470,545, filed on May 13, 2003.

(51) Int. Cl. H04B 7/185

(52) U.S. Cl. 370/312; 370/390

(57) ABSTRACT

A broadcast/narrowcast dual mode satellite is capable of selectively providing narrowcast operations or broadcast operations. The dual-mode satellite includes a broadcast/narrowcast dual-mode receiving system that receives from one or more terrestrial transmitting stations one or more communication uplink signals that selectively correspond to one or more narrowcast communication signals or one or more broadcast communication signals. Narrowcast communication signals are typically distinct from each other and are directed to one or more narrowcast geographic cells. Broadcast communication signals are directed to one or more broadcast regions, each of which encompasses plural narrowcast geographic cells. The dual-mode satellite also includes a broadcast/narrowcast dual-mode transmitting system that transmits one or more communication downlink signals that selectively correspond to broadcast communication signals and narrowcast communication signals received by the receiving system. Dual-mode satellite is capable of operating in the narrowcast mode or the broadcast mode, either separately or simultaneously together.

### FIELD OF THE INVENTION

The present invention relates to satellite communication systems and, in particular, to a communication satellite capable of selectively providing narrowcast and broadcast operations.

### BACKGROUND AND SUMMARY OF THE INVENTION

A conventional communication satellite in geosynchronous orbit has a communication signal receiving system and a communication signal transmitting system. The receiving system includes a satellite receiving reflector that receives multiple communication uplink signals from one or more terrestrial transmitting stations and concentrates the signals at corresponding ones of multiple receiving horns, which pass the communication uplink signals through an input filter system to a satellite low noise amplifier (LNA) and downconverter system.

A communication multiplexer system receives the low noise amplified and frequency converted uplink signals and channelizes and routes the signals to the transmitting system for transmission to terrestrial recipient stations. The transmitting system typically includes an amplifier system, which may include traveling wave tube (TWT) amplifiers, to provide high reliability, high power output amplification. The outputs of the high power amplifier system are connected through an output filter system to one or more transmit horns for transmission as downlink signals via a satellite transmit reflector.

One type of conventional communication satellite directs narrow zone communication signals to recipient stations in multiple cells over a satellite telecommunication region. The cells correspond to different geographic areas within the region and may form a dense-packed or “honeycombed,” optionally overlapping, arrangement that minimizes or eliminates the portions of region not covered by a cell. Next adjacent cells typically receive distinct communication signals or sub-bands.

Another type of conventional communication satellite directs communication signals to no more than four broad geographic regions that each might encompass a major portion of a continent. Such broadcast satellites are configured to provide transmission of the same communication (e.g., television) signals over continental-size geographic regions.

Accordingly, the present invention provides a broadcast/narrowcast dual mode satellite capable of selectively providing narrowcast operations or broadcast operations. In one implementation, the dual-mode satellite includes a broadcast/narrowcast dual-mode receiving system that receives from one or more terrestrial transmitting stations one or more communication uplink signals that selectively correspond to one or more narrowcast communication signals or one or more broadcast communication signals.

Narrowcast communication signals are typically distinct from each other and are directed to one or more narrowcast geographic cells. Broadcast communication signals are directed to one or more broadcast regions, each of which encompasses plural narrowcast geographic cells.

The dual-mode satellite also includes a broadcast/narrowcast dual-mode transmitting system that transmits one or more communication downlink signals that selectively correspond to broadcast communication signals and narrowcast communication signals received by the receiving system. Dual-mode satellite is capable of operating in the narrowcast mode or the broadcast mode, either separately or simultaneously together.

The dual-mode satellite of the present invention uniquely provides both narrowcast and broadcast satellite operations. These combined capabilities, which conventionally were included only in separate satellites, allow a satellite of the present invention to be adapted for optimal use over a wider range of communication applications.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a block diagram of a broadcast/narrowcast dual-mode communication satellite for geosynchronous orbit.

FIG. 2 is an illustration of satellite telecommunications regions to which a dual-mode satellite is capable of directing broadcast and narrowcast communication signals to recipient stations.

FIG. 3 is a circuit block diagram of a dual-mode communication signal receiving system according to one implementation of the present invention.

FIG. 4 is a circuit block diagram of a dual-mode communication signal receiving system according to another implementation of the present invention.

FIG. 5 is a circuit block diagram of one implementation of a dual-mode communication signal transmitting system.

FIG. 6 is a circuit block diagram of another implementation of a dual-mode communication signal transmitting system.

FIG. 7 is a flow diagram of a broadcast/narrowcast dual-mode communication satellite operating method for providing dual-mode satellite operations in accordance with the present invention.

### DETAILED DESCRIPTION OF PREFERRED EMBODIMENTS

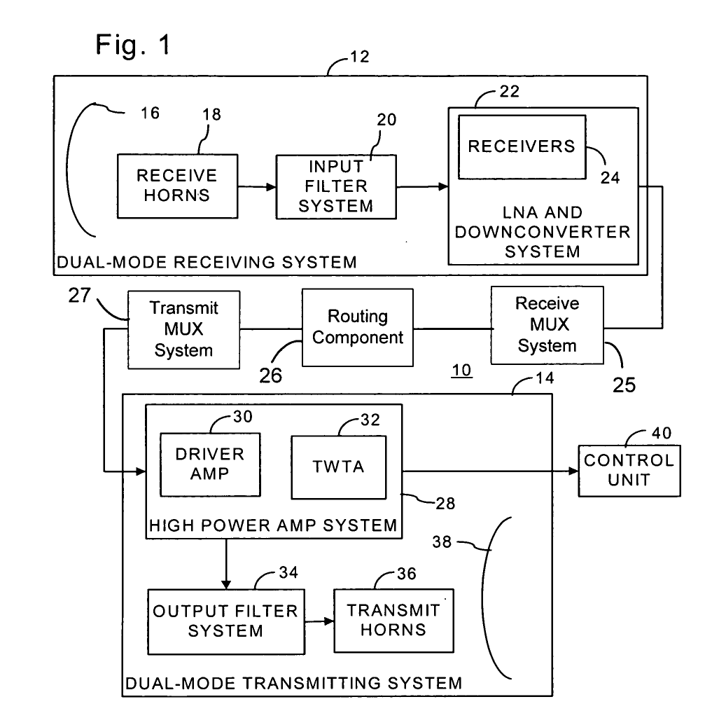

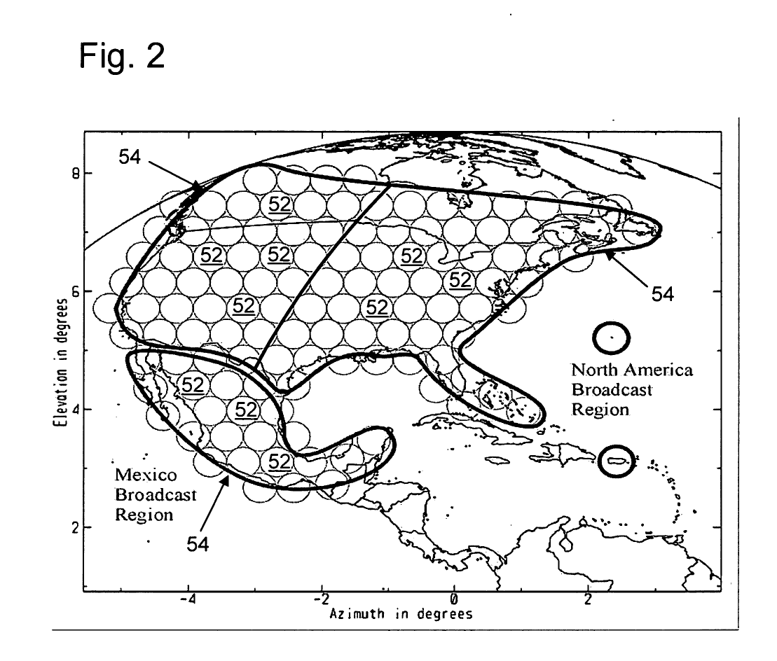

FIG. 1 is a block diagram of a broadcast/narrowcast dual-mode communication satellite 10 for geosynchronous orbit. A narrowcast mode refers to transmitting communication signals to a large number (e.g., 5 or more, potentially several dozens) of terrestrial areas or cells 52 (FIG. 2) of limited geographic extent (e.g., on the scale of an urban area or a major portion of one). A broadcast mode refers to transmitting communication signals to a reduced number of terrestrial broadcast zones 54 (FIG. 2) of extended geographic extent (e.g., on the scale of a nation or a major portion of one), each broadcast zone 54 encompassing multiple cells 52.

Dual-mode communication satellite 10 has a dual-mode communication signal receiving system 12 and a dual-mode communication signal transmitting system 14. Dual-mode receiving system 12 includes a satellite receiving reflector 16 that receives one or more communication uplink signals from one or more terrestrial transmitting stations and concentrates the signals at one or more corresponding receiving horns 18. The one or more communication uplink signals may correspond to one or more broadcast communication signals, one or more narrowcast communication signals, or both types of signals, according to whether satellite 10 is operating in a broadcast mode, a narrowcast mode, or both modes. Receiving horns 18 pass the communication uplink signals through an input filter system 20 to a satellite low noise amplifier (LNA) and downconverter system 22 having multiple individual receivers 24. Each of the uplink communication signals may include multiple separate signals.

Low noise amplifier (LNA) and downconverter system 22 would typically include more individual receivers 24 than are necessary for the number of signals or channels to be handled by satellite 10. The additional receivers 24, or other components, provide redundancy and may be utilized upon the failure of any individual component. Such redundancy is typically utilized in satellite design and may be applied as well as in other systems within satellite 10 that are described below.

Accordingly, low noise amplifier (LNA) and downconverter system 22 includes switching arrays to route each channel of the uplink signal to the corresponding active receivers 24 that provide pre-amplification of the uplink communication signals and convert them to another (e.g., lower) frequency. For example, uplink signals may be Ku-band signals (i.e., about 14 GHz) or V-band signals (i.e. about 49-50 GHz), which may be converted to lower Ku-band frequencies (e.g., 11-12 GHz). A receiver multiplexer system 25 receives the low noise amplified and frequency converted uplink signals and channelizes them to a signal routing component 26. Signal routing component 26 routes the signals to a transmitting multiplexing system 27 for transmission according to their destinations. Transmitting multiplexing system 27 delivers the signals to appropriate ones of redundant high power amplifiers in a high power amplifier system 28 in dual-mode transmitting system 14 for transmission to terrestrial recipient stations.

Signal routing component 26 may be implemented as a routing switch that is carried on-board satellite 10 and selectively routes uplink signals for delivery to one or more different downlink locations. In such an implementation utilizing FDMA routing techniques, multiplexer 26 channelizes and routes the signals according to their carrier frequencies. In another implementation, signal routing component 26 provides fixed connections between receiver multiplexer system 25 and transmitting multiplexer system 27. Alternatively, signal routing component 26 may correspond to satellite downlink and uplink components that downlink received signals to a terrestrial gateway that provides routing of the signals and uplinks them back up to signal routing component 26.

Amplifier system 28 may employ, for example, driver amplifiers 30 with associated traveling wave tube amplifiers 32. Traveling wave tube amplifiers 32 provide high reliability, high power output amplification. The outputs of high power amplifier system 28 are connected through an output filter system 34 to one or more transmit horns 36 for transmission as a downlink signal via a satellite transmit reflector 38. A control unit 40 is bus connected to various ones of these components to control their operation and interaction. The satellite includes power sources, orientation and position control systems, communication control systems, etc. as are known in the art.

FIG. 2 is an illustration of a satellite telecommunications region 50 having multiple cells 52 (represented by circles) to which dual-mode satellite 10 is capable of directing communication signals to recipient stations in a narrowcast operating mode. Each of cells 52 is encompassed by and receives narrowcast communication signals from a single transmit horn 36. Different groups of cells 52 receive downlink signals carried on different channels. In some applications, the downlink signal carried on a single channel could be directed to a single cell 52. As is known in the art, transmit horns 36 are arranged in relation to transmit reflector 38 to transmit particular communication signals to particular ones of cells 52.

Satellite telecommunications region 50 also shows at least one (three shown) broadcast regions 54A-54C to which dual-mode satellite 10 is capable of directing communication signals to recipient stations over extended geographical areas in a broadcast operating mode. Broadcast regions 54A-54C are referred to together or generally as broadcast regions 54. Each of broadcast regions 54 is encompassed by and receives a broadcast communication signal from multiple transmit horns 36.

Broadcast regions 54 are illustrated as encompassing significant continental or national territories. For example, broadcast region 54A encompasses a western portion of the continental United States (sometimes referred to as CONUS) and southern Canada, broadcast region 54B encompasses an eastern portion of the continental United States, southern Canada and selected offshore islands, and broadcast region 54B encompasses Mexico. Broadcast regions 54 of FIG. 2 illustrate a common scope of geosynchronous satellite broadcasting to five or fewer significant geographical areas, and the distinction of such broadcasting from narrowcast transmission to cells 52.

Broadcast regions 54 are each formed from multiple cells 52. The common scope of geosynchronous satellite broadcasting regions 54 shown in FIG. 2 is illustrative of one capability of dual-mode satellite 10. It will be appreciated, however, that forming broadcast regions 54 from multiple smaller cells 52 allows a broadcast region 54 of substantially any size to be formed with any number of multiple cells 52.

The transmitting station transmitting a communication signal to a recipient station may be located in the same cell as, or more commonly a different cell from, that of the recipient station. Satellite 10 also communicates with a communication system or network operations center and a satellite control center. The network operations center, sometimes referred to as a NOC, controls and coordinates the transmission of communication over satellite 10. The network operations center obtains and maintains information about the communication traffic and the resource configuration of satellite. The satellite control center transmits and receives tracking, telemetry, and control signals for controlling satellite 10 and its operation.

The network operations center and the control center may be separate or a single integrated control center. Similarly, the network operations center and the satellite control center could be located in different or the same cells 52, or could be completely outside satellite telecommunications region 50. It will be appreciated that the geographic region shown in FIG. 2 is merely illustrative and that operation of the present invention is applicable to other geographic regions.

With routing based upon frequency division multiple access (FDMA) techniques, for example, the cell 52 within which a recipient station is located is associated with a selected channel or FDMA sub-band (e.g., nominal 167 MHz bandwidth channel) of a nominal 3.5 GHz bandwidth V-band uplink channel between a trerrestrial uplink station and satellite 10. Routing of the communication signal to the recipient station includes modulating and upconverting the communication signal to the selected sub-band. Alternatively, if the recipient station represents multiple separate recipient stations in multiple different cells 52, multiple selected channels or sub-bands associated with the cells 52 are identified and the communication signal is modulated and upconverted to the corresponding sub-bands. The routing of the communication signal may further include application of code division multiple access (CDMA) techniques in which a selected code or identifier associated with the recipient station is associated with the FDMA sub-band signal to direct the communication signal specifically to a particular recipient station within its cell 52.

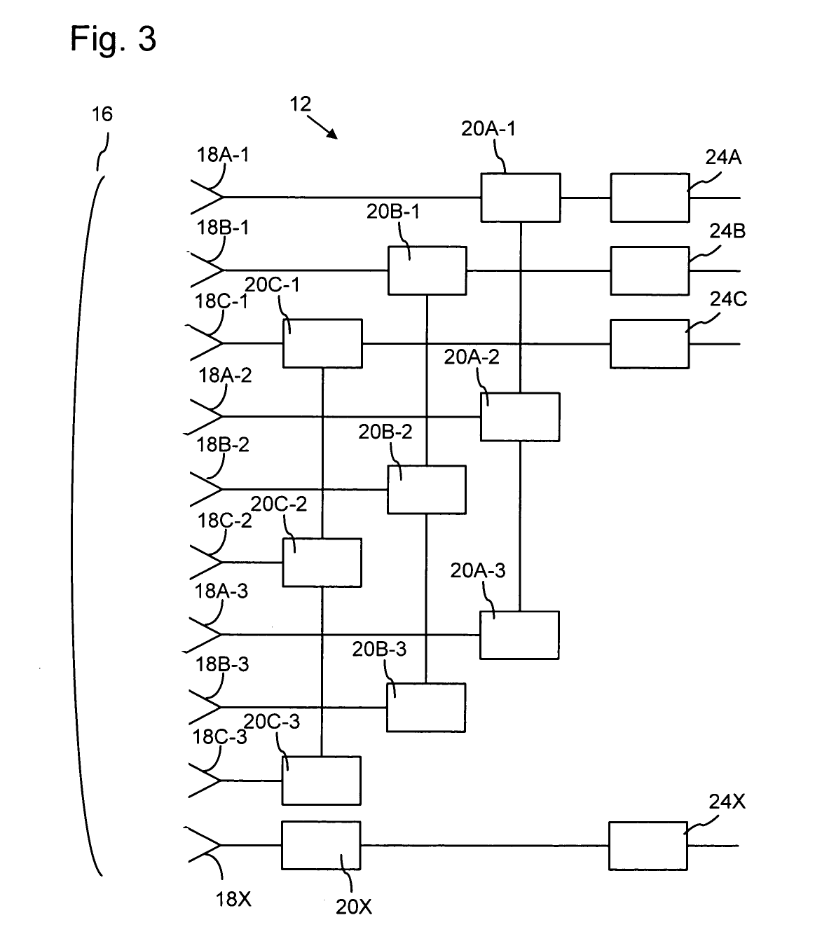

FIG. 3 is a circuit block diagram of dual-mode communication signal receiving system 12 with receivers 24 (only four shown) according to one implementation of the present invention. Narrowcast receivers 24A-24C are multiplexable and receive narrowcast communications signals, and receiver 24X receives broadcast communications signals. Receivers 24A-24C may be referred to as narrowcast receivers 24A-24C, and receiver 24X may be referred to as a broadcast receiver.

In the illustrated implementation, each of narrowcast receivers 24A-24C is multiplexable among three receive horns 18. Each receive horn 18 receives from a transmitting station an uplink communication signal for transmission to a corresponding narrowcast cell 52. It will be appreciated that such 1×3 multiplexing is merely exemplary and that different degrees of multiplexing, or no multiplexing at all, can be applied to narrowcast receivers 24A-24C.

With reference to narrowcast receiver 24A, for example, three input frequency filters 20A-1, 20A-2, and 20A-3 receive different portions or segments of a given uplink frequency band from respective receive horns 18A-1, 18A-2, and 18A-3. As one example, each of narrowcast receivers 24A-24C, including narrowcast receiver 24A, is adapted to receive and amplify all of the nominal 500 MHz bandwidth of a Ku-band uplink communication channel. Accordingly, input frequency filters 20A-1, 20A-2, and 20A-3 pass signals with frequencies within different nominal 167 MHz sub-bands of the Ku-band channel. With a Ku-band downlink communication channel of 12.200-12.700 GHz, frequency filter 20A-1 could pass communication signals for frequencies in the sub-band 12.200-12.367 Ghz, frequency filter 20A-2 could pass communication signals for frequencies in the sub-band 12.367-12.533 Ghz, and frequency filter 20A-3 could pass communication signals for frequencies in the sub-band 12.533-12.700 Ghz. It will be appreciated that references to the KU-band uplink communication channel is only illustrative and is not a limitation on the scope of application for receiving system 12.

Broadcast receiver 24X is in communication with receive horn 18X via an input frequency filter 20X. Receive horn 18X receives from a transmitting station an uplink broadcast communication signal for simultaneous transmission to multiple cells 52. For example, input frequency filter 20X passes signals within the Ku-band uplink communication channel.

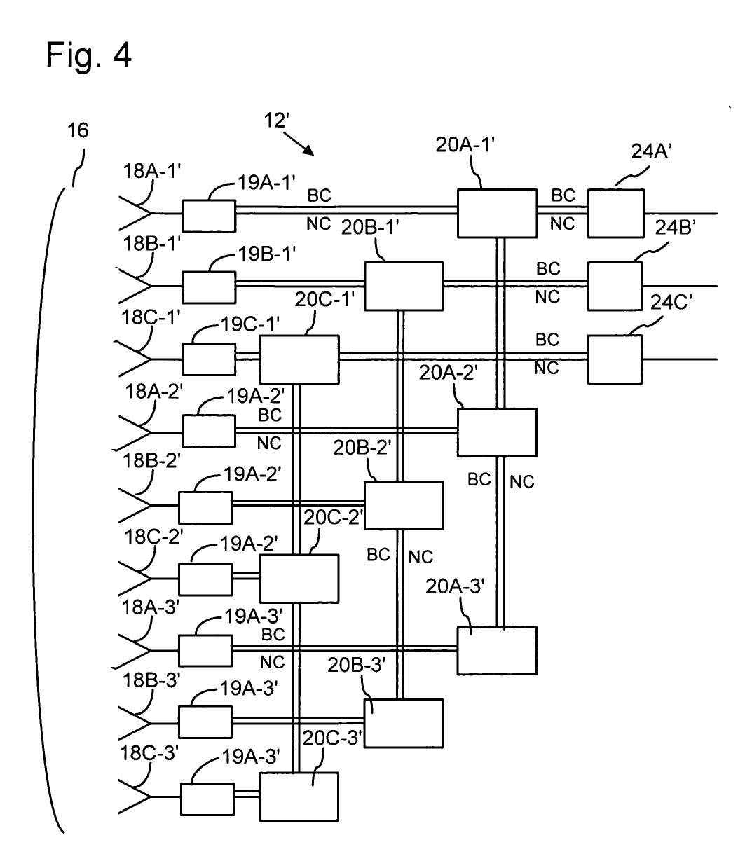

FIG. 4 is a circuit block diagram of another implementation of a dual-mode communication signal receiving system 12′ with receivers 24′ (only four shown) according to one implementation of the present invention. Narrowcast receivers 24A′-24C′ are multiplexable and receive narrowcast and broadcast communications signals.

In the illustrated implementation, each of narrowcast receivers 24A′-24C′ is multiplexable among three receive horns 18′. Each receive horn 18′ receives from a transmitting station an uplink communication signal that may include a narrowcast signal for transmission to a corresponding narrowcast cell 52, or a broadcast, or both. It will be appreciated that such 1×3 multiplexing is merely exemplary and that different degrees of multiplexing, or no multiplexing at all, can be applied to narrowcast receivers 24A′-24C′.

With reference to receiver 24A′, for example, diplexers 19A-1, 19A-2 and 19A-3 split or separate any broadcast and narrowcast signals and delivers them to respective input frequency filters 20A-1′, 20A-2′, and 20A-3′, which receive different portions or segments of a given uplink frequency band from respective receive horns 18A-1′, 18A-2′, and 18A-3′, as described above with reference to FIG. 3, for both broadcast and narrowcast bands. The implementation of FIG. 4 allows signal receiving system 12′ to operate without the dedicated receive horn and related elements for broadcast signals included in the implementation of FIG. 3.

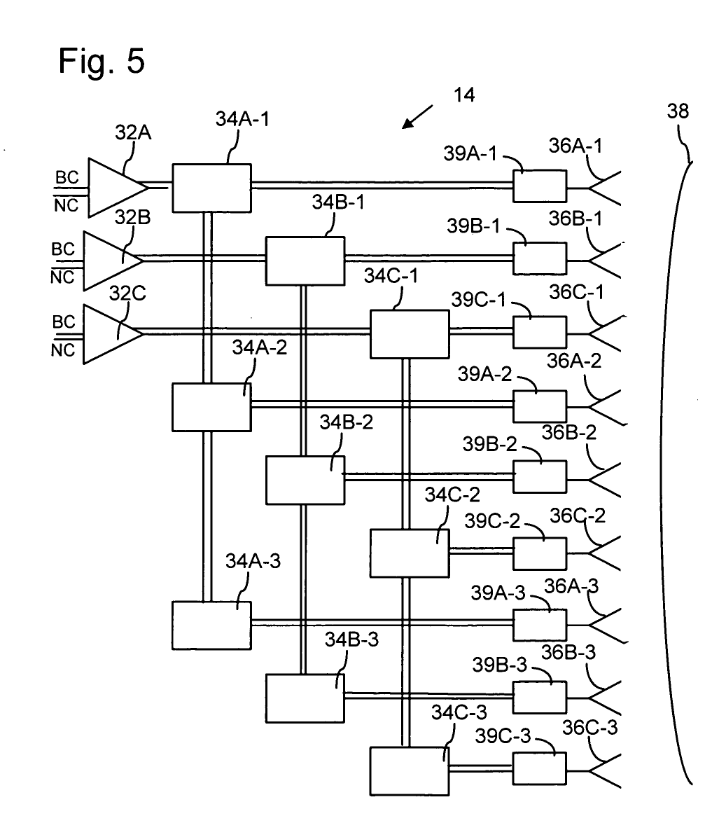

FIG. 5 is a circuit block diagram of one implementation of dual-mode communication signal transmitting system 14, which includes multiplexed traveling wave tube (TWT) amplifiers 32 (only three shown) according to the present invention. In the illustrated implementation, each TWT amplifier 32 is multiplexed among three transmit horns 36. Each transmit horn 36 is capable of transmitting a downlink communication signal to a corresponding one of narrowcast cells 52 (FIG. 2). It will be appreciated, however, that the illustrated 1×3 multiplexing is merely exemplary and that greater or lesser degrees of multiplexing can be applied to TWT power amplifiers 32.

With reference to TWT amplifier 32A, for example, three output frequency filters 34A-1, 34A-2, and 34A-3 pass different portions or segments of a given narrowcast output frequency band and a given broadcast output frequency band to respective transmit horns 36A-1, 36A-2, and 36A-3. With reference to a narrowcast frequency band, for example, each TWT amplifier 32, including TWT amplifier 32A, is adapted to amplify and transmit all of the nominal 500 MHz bandwidth of a Ku-band downlink communication channel. Accordingly, output frequency filters 34A-1, 34A-2, and 34A-3 pass signals with frequencies within different nominal 167 MHz sub-bands of the Ku-band channel. With a Ku-band downlink communication channel of 12.200-12.700 GHz, frequency filter 34A-1 could pass communication signals for frequencies in the sub-band 12.200-12.367 Ghz, frequency filter 34A-2 could pass communication signals for frequencies in the sub-band 12.367-12.533 Ghz, and frequency filter 34A-3 could pass communication signals for frequencies in the sub-band 12.533-12.700 Ghz. TWT amplifier 32A operates in a similar manner with respect to a broadcast frequency band. It will be appreciated that references to the KU-band downlink communication channel is only illustrative and is not a limitation on the scope of application for transmitting system 14.

TWT amplifiers 32 receive narrowcast (NC) or broadcast (BC) communication signals. In this implementation, diplexers 39 combine or sum together broadcast and narrowcast communication signals that are directed to a common area (e.g., cell) for transmission through a corresponding horn 36.

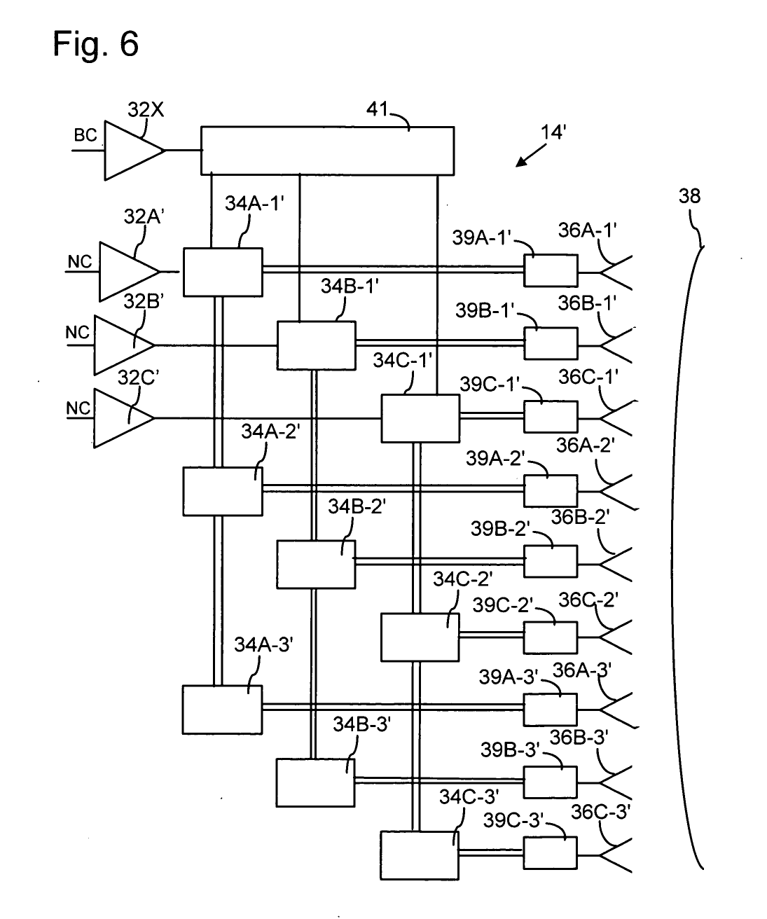

FIG. 6 is a circuit block diagram of another implementation of dual-mode communication signal transmitting system 14′, which includes multiplexed narrowcast traveling wave tube (TWT) amplifiers 32′ (only three shown) and a broadcast traveling wave tube (TWT) amplifier 32X. In the illustrated implementation, each narrowcast TWT amplifier 32′ is multiplexed among three transmit horns 36′ and broadcast amplifier 32X is multiplexed among all transmit horns 36′ with a broadcast multiplexer 41 operating in conjunction with components multiplexing the narrowcast signals. Each transmit horn 36′ is capable of transmitting a downlink communication signal to a corresponding one of cells 52 (FIG. 2). It will be appreciated, however, that the illustrated 1×3 multiplexing is merely exemplary and that greater or lesser degrees of multiplexing can be applied to TWT power amplifiers 32′.

With reference to TWT amplifier 32A′, for example, three output frequency filters 34A-1′, 34A-2′, and 34A-3′ pass different portions or segments of a given narrowcast output frequency band and a given broadcast output frequency band to respective transmit horns 36A-1′, 36A-2′, and 36A-3′. With reference to a narrowcast frequency band, for example, each TWT amplifier 32′, including TWT amplifier 32A′, is adapted to amplify and transmit all of the nominal 500 MHz bandwidth of a Ku-band downlink communication channel.

TWT amplifiers 32A′-32C′ receive narrowcast (NC) communication signals and TWT amplifier 32X receives broadcast (BC) communication signals. In this implementation, diplexers 39 combine or sum together broadcast and narrowcast communication signals that are directed to a common area (e.g., cell) for transmission through a corresponding horn 36′.

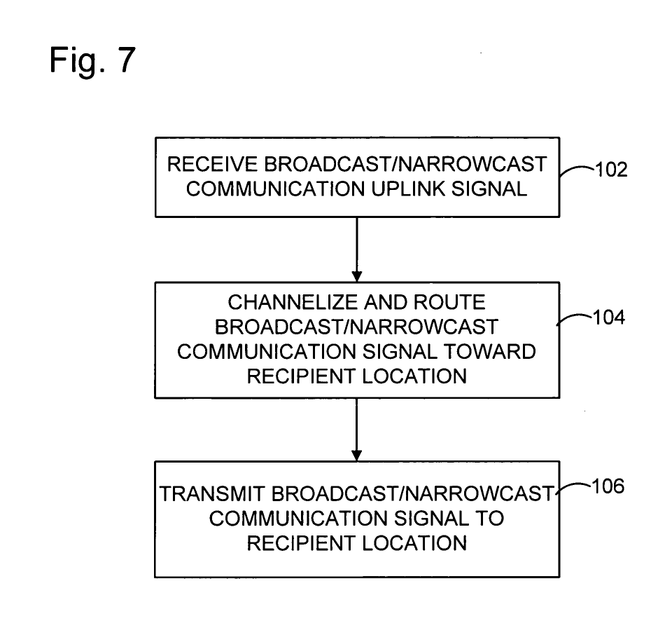

FIG. 7 is a flow diagram of a broadcast/narrowcast dual-mode communication satellite operating method 100 for providing dual-mode satellite operations in accordance with the present invention.

In step 102, one or more broadcast or narrowcast communication uplink signals are received from one or more terrestrial transmitting stations. The one or more broadcast or narrowcast communication uplink signals selectively correspond to one or more narrowcast communication signals directed to one or more narrowcast geographic cells or one or more broadcast cast communication signals directed to one or more broadcast regions, respectively. Each broadcast region encompasses multiple narrowcast geographic cells.

In step 104, the broadcast/narrowcast communication uplink signals are selectively channelized and routed according to locations where they are to be transmitted.

In step 106, one or more broadcast or narrowcast communication downlink signals are transmitted selectively to one or more broadcast regions or one or more narrowcast geographic cells. In step 105, transmission of the one or more broadcast or narrowcast communication downlink signals may include transmitting only one or more narrowcast downlink signals, only one or more broadcast downlink signals, or simultaneously transmitting broadcast and narrowcast communication signals. Simultaneous transmission of broadcast and narrowcast communication signals may include transmitting both broadcast and narrowcast communication signals to some geographic cells.

In view of the many possible embodiments to which the principles of our invention may be applied, it should be recognized that the detailed embodiments are illustrative only and should not be taken as limiting the scope of our invention. Accordingly, the invention includes all such embodiments as may come within the scope and spirit of the following claims and equivalents thereto.

1. In a communication satellite for operation in Earth orbit, the improvement comprising:
a broadcast/narrowcast dual-mode receiving system that receives from one or more terrestrial transmitting stations one or more communication uplink signals that selectively correspond to one or more narrowcast communication signals directed to one or more narrowcast geographic cells or one or more broadcast communication signals directed to one or more broadcast regions, each of which encompasses plural narrowcast geographic cells; and
a broadcast/narrowcast dual-mode transmitting system that transmits one or more communication downlink signals that selectively correspond to the one or more broadcast communication signals being transmitted to the one or more broadcast regions or the one or more narrowcast communication signals being transmitted to the one or more narrowcast geographic cells.

2. The communication satellite of claim 1 in which the dual-mode transmitting system simultaneously transmits communication downlink signals corresponding to one or more broadcast communication signals and one or more narrowcast communication signals.

3. The communication satellite of claim 2 in which the dual-mode transmitting system simultaneously transmits communication downlink signals corresponding to a broadcast communication signal and a narrowcast communication signal to each of plural geographic cells.

4. The communication satellite of claim 1 in which the dual-mode transmitting system transmits communication downlink signals corresponding to only to one or more broadcast communication signals.

5. The communication satellite of claim 1 in which the dual-mode transmitting system transmits communication downlink signals corresponding only to one or more narrowcast communication signals.

6. A communication satellite for operation in Earth orbit, comprising:
a broadcast/narrowcast dual-mode receiving system that receives from one or more terrestrial transmitting stations one or more communication uplink signals that selectively correspond to one or more narrowcast communication signals directed to one or more narrowcast geographic cells or one or more broadcast cast communication signals directed to one or more broadcast regions, each of which encompasses plural narrowcast geographic cells;
a broadcast/narrowcast dual-mode transmitting system that transmits one or more communication downlink signals that selectively correspond to the one or more broadcast communication signals being transmitted to the one or more broadcast regions or the one or more narrowcast communication signals being transmitted to the one or more narrowcast geographic cells; and
a dual-mode communication multiplexer and routing system that selectively channelizes and routes signals between dual-mode receiving system and dual-mode transmitting system for directing transmission of the broadcast or narrowcast communication signals.

7. The communication satellite of claim 6 in which the dual-mode communication multiplexer and routing system includes one or more diplexers for summing broadcast and narrowcast communication signals directed to common locations.

8. The communication satellite of claim 6 in which the dual-mode transmitting system simultaneously transmits communication downlink signals corresponding to one or more broadcast communication signals and one or more narrowcast communication signals.

9. The communication satellite of claim 8 in which the dual-mode transmitting system simultaneously transmits communication downlink signals corresponding to a broadcast communication signal and a narrowcast communication signal to each of plural geographic cells.

10. The communication satellite of claim 6 in which the dual-mode transmitting system transmits communication downlink signals corresponding to only to one or more broadcast communication signals.

11. The communication satellite of claim 6 in which the dual-mode transmitting system transmits communication downlink signals corresponding only to one or more narrowcast communication signals.

12. A communication satellite method of operation, comprising:
receiving from one or more terrestrial transmitting stations one or more broadcast/narrowcast communication uplink signals that selectively correspond to one or more narrowcast communication signals directed to one or more narrowcast geographic cells or one or more broadcast communication signals directed to one or more broadcast regions, respectively, each broadcast region encompassing plural narrowcast geographic cells;
selectively channelizing and routing the broadcast/narrowcast communication uplink signals according to locations where they are to be transmitted; and
transmitting one or more broadcast/narrowcast communication downlink signals that selectively correspond to the one or more broadcast communication signals being transmitted to the one or more broadcast regions or the one or more narrowcast communication signals being transmitted to the one or more narrowcast geographic cells.

13. The method of claim 12 in which transmitting the one or more broadcast/narrowcast communication downlink signals includes simultaneously transmitting communication downlink signals corresponding to one or more broadcast communication signals and to one or more narrowcast communication signals.

14. The method of claim 13 in which further including simultaneously transmitting communication downlink signals corresponding to a broadcast communication signal and a narrowcast communication signals to each of plural geographic cells.

15. The method of claim 12 in which transmitting the one or more broadcast/narrowcast communication downlink signals includes transmitting only one or more broadcast communication signals.

16. The method of claim 12 in which transmitting the one or more broadcast/narrowcast communication downlink signals includes transmitting only one or more narrowcast communication signals.
